(19) United States
(12) Patent Application Publication
(10) Pub. No.: US 2006/0070963 A1
(43) Pub. Date: Apr. 6, 2006

(54) Method and apparatus for separating contaminants in fluids and gas

(76) Inventor: Leonard Eugene McKeary, Chestermere (CA)

Correspondence Address: HICKS & PENMAN LTD., 3553 31ST STREET NW, SUITE 123, CALGARY, AB, T2L2K7, CA

(21) Appl. No.: 10/956,068

(22) Filed: Oct. 4, 2004

(51) Int. Cl. C02F 1/52

(52) U.S. Cl. 210/787; 210/702

(57) ABSTRACT

The present invention relates generally to promote separating and filtering contaminants from a mixture of water with oil and/or gas. More particularly, the present invention relates to a method and apparatus for separating contaminants within fluids and gases utilizing a galvanic effect from dissimilar metals within the apparatus.

### FIELD OF THE INVENTION

The present invention relates generally to promote separating and filtering contaminants from a mixture of water with oil and/or gas. More particularly, the present invention relates to a method and apparatus for separating contaminants within fluids and gases utilizing a galvanic effect from dissimilar metals within the apparatus.

### BACKGROUND OF THE INVENTION

As is known, during oil production from producing wells, steam is often injected into wells to reduce the viscosity of oil in the formation and assist in the mobilization of the oil towards the well bore for subsequent pumping to the surface. During the process, the steam condenses to water and is recovered from the well typically as a mixture of water containing dissolved minerals and suspended particulates along with varying amounts of oil and/or gas.

After the mixture of water, oil and gas is pumped to the surface, the mixture is then passed through a separator to separate the water from the oil and gas. After separation, the oil/gas is delivered to further downstream processing and/or transportation systems and the recovered water is sent to a cleaning station to both clean remaining dissolved oil/gas from the recovered water and to treat the water to remove any dissolved minerals or suspended particulates. After cleaning, the water may be disposed of or re-used.

In today's industries, various separation methods are used to separate oil and/or gas from the produced water. The simplest type of equipment is a gravity tank where water, which is heavier than oil, is recovered from the lowest level of the separation vessel, and oil, which is heavier than gas, is recovered from a higher region of the vessel. Gas, is generally recovered from the top of the vessel.

Other types of separators include centrifugal separators (either vertical or horizontal separators) that generally use centrifugal force in addition to gravity to separate produced well fluids. Separators may be two-phase or three-phase devices that separate the well fluids into liquid and gas phases or oil, gas and water phases, respectively.

In most conventional systems however, as noted above, the separated water may still contain some oil and gas after the primary separation process. In addition, many separators inadequately remove suspended particulate matter from the water, thereby suggesting the need for superior separation systems.

Accordingly, in view of the above-mentioned deficiencies in the art, it is desirable to provide an improved method and apparatus for separating contaminants in fluids and gas. More specifically, there has been a need for a separation system that imparts an electrical charge to mixtures containing suspended particulates that enables improved separation of oil/gas and water from one another and improved coagulation of suspended particles for subsequent filtration or settling.

### SUMMARY OF THE INVENTION

In accordance with the invention, there is provided an apparatus for promoting the separation of dissolved and suspended contaminants from an electrically conductive mixture of water with gas and/or oil, the apparatus comprising: an electrically conductive chamber having an entry end and an exit end for containing the mixture of water with gas and/or oil; a first screen of an electrically conductive metal operatively and electrically connected to the entry end of the chamber for directing the mixture into the chamber; at least one second screen of an electrically conductive metal operatively and electrically connected to the chamber for contacting the mixture and promoting the formation of bubbles; at least one helical surface of an electrically conductive metal operatively and electrically connected to the chamber for contacting the mixture; wherein the metals of the first screen, second screen and helical surface are selected in order to establish at least one galvanic effect between at least one of the first screen, second screen and helical surface.

In accordance with a further embodiment, the metals are selected from combinations of copper, zinc, tin, molybdenum, nickel or aluminium or alloys thereof that establish a galvanic effect.

In a more particular embodiment, the first screen is 50 to 80 per cent copper, 2 to 20 per cent zinc, 1 to 20 per cent nickel, 1 to 10 per cent aluminium, and 1 to 30 per cent brass and/or the first screen includes a plurality of cone-shaped holes for causing a jetting action of the mixture towards the at least one second screen.

In accordance with another embodiment, the invention provides a method of promoting the separation of dissolved and suspended contaminants from an electrically conductive mixture of water with gas and/or oil, comprising the steps of:
a) introducing an electrically conductive mixture of water with gas and/or oil into an electrically conductive chamber having an entry end and an exit end through a first screen of an electrically conductive metal operatively and electrically connected to the entry end of the chamber;
b) passing the fluid through at least one second screen of an electrically conductive metal operatively and electrically connected to the chamber, the at least one second screen for contacting the mixture and promoting the formation of bubbles;
c) impinging the fluid on at least one helical surface of an electrically conductive metal operatively and electrically connected to the chamber; and,
d) passing the fluid from step c) to a further settling or filtration apparatus for separating coagulated particles formed by steps a)-c).

### BRIEF DESCRIPTION OF THE DRAWINGS

Embodiments of the present invention will now be described, by way of example only, with reference to the attached Figures, wherein:

FIG. 1 is a longitudinal cross-sectional view of an apparatus for separating contaminants in fluids and gas in accordance with an embodiment of the present invention;

FIG. 2a is a perspective view of an entry plate in accordance with the present invention;

FIG. 2b is a front view of an entry plate in accordance with the present invention;

FIG. 3a is a perspective view of a screen in accordance with an embodiment of the present invention; and,

FIG. 3b is a front view of a screen in accordance with and embodiment of the invention.

### DETAILED DESCRIPTION

Generally, the present invention provides a simple system to augment the separation and filtering process for mixtures of water, oil, and gas.

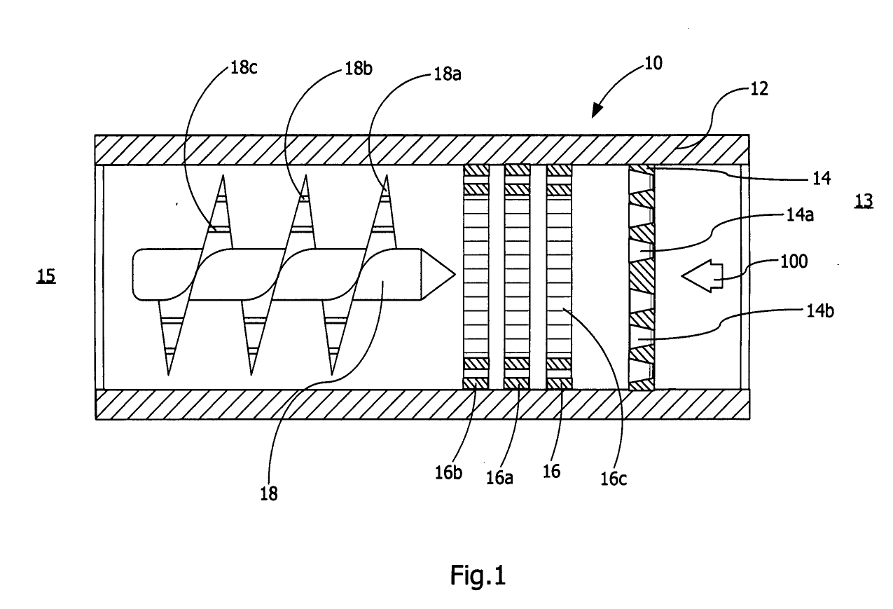

In FIG. 1 there is illustrated an apparatus to separate contaminants in fluids and gas. A separating apparatus 10 includes a chamber such as a cylindrical tube 12 through which water/oil/gas mixtures may be passed. The apparatus 10 includes an entry plate 14 welded or otherwise attached to the inside of the cylindrical tube 12, at least one wire screen and preferably multiple wire screens 16 16a 16b located at suitable intervals downstream of the plate 14 and a helical surface 18 downstream of the screens 16 16a 16b. Generally, the plate 14, screens 16 16a 16b and perforated helical surface 18 are various combinations of dissimilar metals or metal alloys.

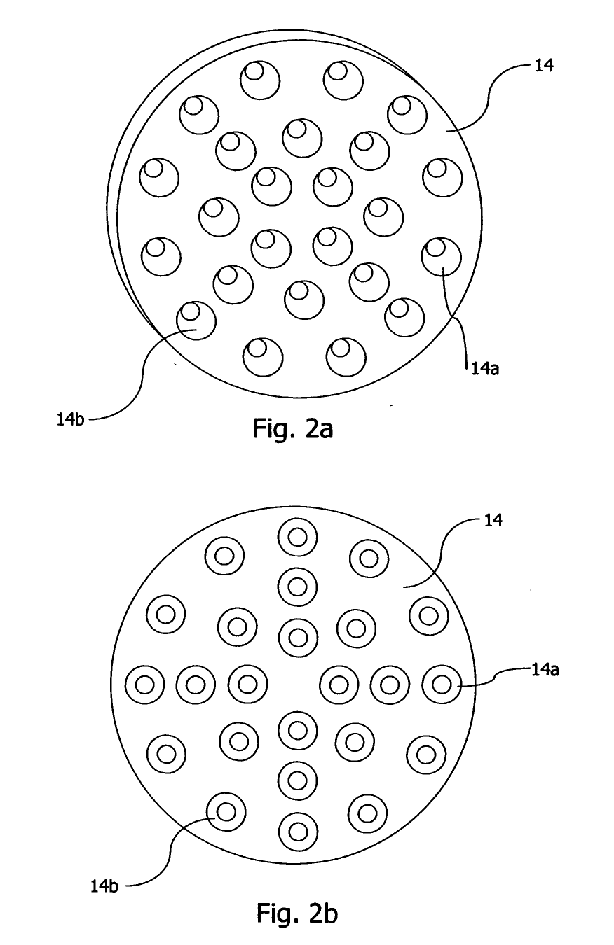

In operation, a mixture 100 of water with oil and/or gas is introduced under high pressure (typically greater than 50 psi) into the separating apparatus 10 at an upstream end 13. The mixture 100 of water with oil and/or gas passes through the plate 14 which has a series of nozzles 14a 14b as shown in FIG. 2a and FIG. 2b, through screens 16, 16a, 16b and over helical surface 18 before exiting the apparatus at the downstream end 15.

The plate 14 is a metal or alloy such as copper, zinc, bronze, brass, tin, molybdenum, nickel or aluminium. Similarly, the screens and helical surface 18 are also metal or metal alloys such as those for the plate but being selected such that a galvanic effect is established between the plate 14, screens 16 16a 16b and helical surface 18. In addition, the outer tube 12 is of an electrically conductive material and each of the plate, screens and helical surface are in electrical contact with the outer tube 12. Accordingly, the system is designed such that dissimilar metals within the system cause a galvanic potential difference to be established across the various gaps between the plate, screens and helical surface. As a result, the mixture 100, being conductive due to the presence of dissolved minerals within the mixture, enables the transfer of electrons between the metals in accordance with various oxidation/reduction reactions. The transfer of charge imparts surface charge to the particulates within the mixture which assists in the coagulation of particles with one another. Furthermore, and as a result of the galvanic effects during the separation process, at least one of the entry plate, screens or helical surface of the system will be consumed during use.

The nozzles 14a 14b are preferably cone shaped holes which provide a jetting action of the mixture 100 toward the screens 16 16a 16b. As the jetted mixture impinges upon the screens, the combination of the jetting action and the screens cause a high level of bubbles to be formed within the mixture as the mixture is mixed with air and broken up by the screens. The high surface area of the bubbles along with the charged nature of the particulates promotes coagulation of particulates. The plate is also designed to provide a resistance to flow to cause a pressure drop across the nozzles so as to promote fluid acceleration towards the screens

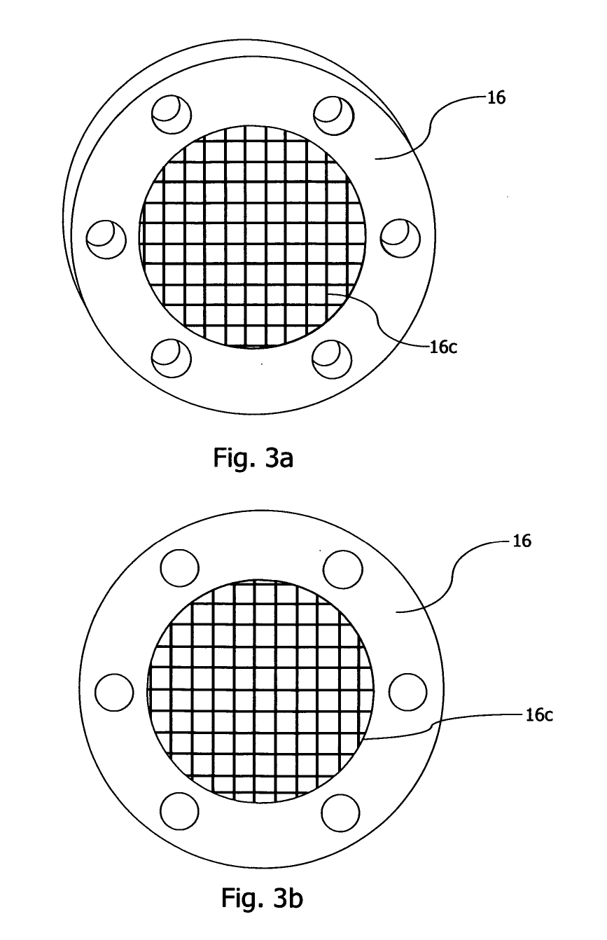

In one embodiment, the screens (a screen being shown generically in FIG. 3a and FIG. 3b) may have a variety mesh sizes that promotes the formation of different size bubbles. Similarly, the nozzles 14a 14b are also sized so as to promote the formation of a large amount of bubbles and maximize the degree of cavitation within the fluid.

After the mixture has passed through the screens, the mixture hits the helical surfaces 18 whereby the mixture is outwardly deflected causing the mixture to mix further as the mixture is both decelerated and deflected. By the time the mixture has reached the exit side 15 of the tube, charged particulates will tend to coagulate forming larger sized particles for subsequent filtration or settling in a downstream filter system or settling system. The helical surfaces are also preferably roughened so as to also increase the degree of turbulence within the system and may include perforations 18a 18b 18c. As noted above, the helical surfaces 18 are a metal or metal alloy selected to provide the galvanic effect. Suitable metals and alloys may be selected from, but not limited to, bronze, copper, zinc, and aluminium.

Further embodiments to those described above may also be provided. In one embodiment, additional screens are provided having different mesh sizes of different metals. For example, in one embodiment two series of brass, bronze and copper screens may be provided in series for a total of six screens. Embodiments of at least 20 screens are also envisaged. The mesh sizes of the screens preferably vary from approximately a 60 to a 12 mesh size.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An apparatus for promoting the separation of dissolved and suspended contaminants from an electrically conductive mixture of water, the apparatus comprising:
an electrically conductive chamber having an entry end and an exit end for containing the mixture of water;
a first screen of an electrically conductive metal operatively and electrically connected to the entry end of the chamber for directing the mixture into the chamber;
at least one second screen of an electrically conductive metal operatively and electrically connected to the chamber for contacting the mixture and promoting the formation of bubbles;
at least one helical surface of an electrically conductive metal operatively and electrically connected to the chamber for contacting the mixture;
wherein the metals of the first screen, second screen and helical surface are selected in order to establish at least one galvanic effect between at least one of the first screen, second screen and helical surface.

2. The apparatus as in claim 1 wherein the metals are selected from combinations of copper, zinc, tin, molybdenum, nickel or aluminium or alloys thereof that establish a galvanic effect.

3. The apparatus for separating contaminants according to claim 1, wherein the first screen is 50 to 80 per cent copper, 2 to 20 per cent zinc, 1 to 20 per cent nickel, 1 to 10 per cent aluminium, and 1 to 30 per cent brass.

4. The apparatus for separating contaminants according to claim 1, wherein the first screen includes a plurality of cone-shaped holes for causing a jetting action of the mixture towards the at least one second screen.

5. The apparatus for separating contaminants according to claim 1, having a mesh size of 12 to 60.

6. A method for promoting the separation of dissolved and suspended contaminants from an electrically conductive mixture of water, comprising the steps of:
a) introducing an electrically conductive mixture of water into an electrically conductive chamber having an entry end and an exit end through a first screen of an electrically conductive metal operatively and electrically connected to the entry end of the chamber;
b) passing the fluid through at least one second screen of an electrically conductive metal operatively and electrically connected to the chamber, the at least one second screen for contacting the mixture and promoting the formation of bubbles;
c) impinging the fluid on at least one helical surface of an electrically conductive metal operatively and electrically connected to the chamber; and,
d) passing the fluid from step c) to a further settling or filtration apparatus for separating coagulated particles formed by steps a)-c).

7. A method as in claim 6 wherein the metals of the first screen, second screen and helical surface are selected in order to establish at least one galvanic effect between at least one of the first screen, second screen and helical surface.
